(19) United States
(12) Patent Application Publication
(10) Pub. No.: US 2009/0120703 A1
(43) Pub. Date: May 14, 2009

(54) Structure for mounting power supply device in vehicle

(76) Inventor: Shuuichi Nagata, Aichi-ken (JP)

Correspondence Address: KENYON & KENYON LLP, 1500 K STREET N.W., SUITE 700, WASHINGTON, DC, 20005, US

(21) Appl. No.: 11/990,330

(22) PCT Filed: Sep. 4, 2006
(86) PCT No.: PCT/JP2006/317927

§ 371 Date: Feb. 12, 2008

(30) Foreign Application Priority Data
Sep. 8, 2005 (JP) 2005-260553

(51) Int. Cl. B60K 1/04

(52) U.S. Cl. 180/68.5

(57) ABSTRACT

A structure for mounting a battery pack in a vehicle includes a battery set mounted in the vehicle, auxiliary machinery electrically connected to the battery set for using the battery set, a battery case housing the battery set, and an auxiliary machinery case housing the auxiliary machinery. The battery case and the auxiliary machinery case are disposed such that a portion of the auxiliary machinery case projected in the vertical direction overlaps with the battery case. According to this configuration, the structure for mounting the power supply device in the vehicle having excellent mountability is provided.

### TECHNICAL FIELD

The present invention generally relates to a structure for mounting a power supply device in a vehicle, and more particularly to a structure for mounting a power supply device in a vehicle, provided with auxiliary machinery for using the power supply.

### BACKGROUND ART

With regard to the conventional structure for mounting a power supply device in a vehicle, for example, Japanese Patent Laying-Open No. 2005-153827 discloses a vehicular power storage device aiming to reduce the number of components and the number of manufacturing processes. The vehicular power storage device disclosed in this reference includes a battery which is a direct-current (DC) power supply, and a battery protecting unit in which a main switch, a main fuse, a battery current sensor for detecting an overcurrent, a contactor interrupting an output circuit of the battery, and the like are collectively provided. The battery and the battery protecting unit are arranged in line in the width direction of the vehicle.

Japanese Patent Laying-Open No. 2004-6415 discloses a battery power supply device aiming to realize the stable operation of the vehicle using a battery power supply. In the battery power supply device disclosed in this reference, the battery back housing a battery module has a side surface provided with a charging and discharging circuit unit housing a relay, a current sensor and the like, and a battery ECU detecting the state of the battery capacity of the battery pack.

Furthermore, Japanese Patent Laying-Open No. 2002-190288 discloses a vehicular power supply device aiming to replace a battery set in a short period of time. In the vehicular power supply device disclosed in this reference, a battery set comprised of a plurality of battery modules and an electrical control circuit component controlling the voltage, the current, the temperature and the like of the battery module are arranged adjacent to each other in the horizontal direction.

In the above-described references, the power supply (battery) and the auxiliary machinery electrically connected to the power supply for using thereof are arranged adjacent to each other in the horizontal direction. Particularly in Japanese Patent Laying-Open Nos. 2005-153827 and 2004-6415, the power supply and the auxiliary machinery are arranged adjacent to each other in the longitudinal direction of the power supply. This configuration causes an increase in the overall length of the power supply device, which leads to a restriction on the process of mounting the power supply device in the vehicle. Specifically, in the case where the power supply device is mounted with its longer side extending in the width direction of the vehicle or mounted in the front and end portions of the vehicle, it may become difficult to ensure a clearance between the power supply device and the body in consideration of the collision of the vehicle.

### DISCLOSURE OF THE INVENTION

An object of the present invention is to solve the above-described problems and to provide a structure for mounting a power supply device in a vehicle which has excellent mountability.

A structure for mounting a power supply device in a vehicle according to the present invention includes a power supply mounted in the vehicle, auxiliary machinery electrically connected to the power supply for using the power supply, a first casing housing the power supply, and a second casing housing the auxiliary machinery. The first and second casings are disposed such that at least a portion of the second casing projected in the vertical direction overlaps with the first casing.

The power supply refers to that used as a source for supplying electric power as energy to an electric motor and the like.

According to the structure for mounting the power supply device in the vehicle configured in this way, the first and second casings are arranged so as to overlap one on top of the other. Thus, the projected area of the first and second casings as seen from above the vehicle can be reduced as compared to the case where the first and second casings are arranged side by side. This allows the mountability of the power supply device in the vehicle to be improved, and also allows the clearance to be readily ensured between the power supply and the body in the longitudinal direction of the vehicle and in the width direction of the vehicle having the possibility of collision. In addition, the heavy-weight power supply and the auxiliary machinery are provided in different casings, which allows an improvement in the workability at the time of the service of the power supply device.

Furthermore, the power supply is mounted in a luggage room provided on the rear side of the vehicle. The structure for mounting the power supply device in the vehicle configured in this way can more effectively achieve the above-described effect of readily ensuring the clearance between the power supply and the body in the longitudinal direction of the vehicle in consideration of the rear-end collision of the vehicle.

Preferably, the vehicle has an opening formed for loading and unloading luggage into and from the luggage room. The head of a bolt fastening the second casing on the side of the vehicle body faces toward the opening.

Furthermore, the first casing is formed in an approximately rectangular parallelepiped shape having a direction of a longer dimension and a direction of a shorter dimension, as seen from above the vehicle. The power supply is mounted in the vehicle such that the width direction of the vehicle approximately corresponds to the direction of the longer dimension and the longitudinal direction of the vehicle approximately corresponds to the direction of the shorter dimension. The structure for mounting the power supply device in the vehicle configured in this way can more effectively achieve the above-described effect of readily ensuring the clearance between the power supply and the body in the width direction of the vehicle in consideration of the side collision of the vehicle.

Preferably, the structure for mounting the power supply device in the vehicle further includes a support portion supporting the first casing in a position spaced apart from an installation surface within the vehicle. The second casing is disposed in a position spaced apart from the installation surface between the installation surface and the first casing. According to the structure for mounting the power supply device in the vehicle configured in this way, the first casing housing the heavy-weight power supply can be reliably supported. Furthermore, even when the auxiliary machinery is disposed under the power supply, the weight of the power supply can be prevented from being applied to the auxiliary machinery.

Preferably, the structure for mounting the power supply device in the vehicle further includes a metallic support portion supporting the first casing in a position spaced apart from the installation surface within the vehicle. The second casing is disposed between the installation surface and the first casing. According to the structure for mounting the power supply device in the vehicle configured in this way, the first casing housing the heavy-weight power supply can be reliably supported. Furthermore, the metallic support portion can block the electromagnetic wave.

As described above, according to the present invention, a structure for mounting a power supply device in a vehicle having excellent mountability can be provided.

### BRIEF DESCRIPTION OF THE DRAWINGS

FIG. 1 is a plan view of a hybrid vehicle to which a structure for mounting a battery pack in a vehicle in a first embodiment of the present invention is applied.

FIG. 2 is a rear view of the battery pack as seen from the direction indicated by an arrow II in FIG. 1.

FIG. 3 is a perspective view showing an exploded view of the battery pack in FIG. 1.

FIG. 4 is a perspective view showing another exploded view of the battery pack in FIG. 1.

FIG. 5 is a perspective view showing still another exploded view of the battery pack in FIG. 1.

FIG. 6 is a perspective view of the battery case which is a component of the battery pack in FIG. 1.

FIG. 7 is a plan view of a hybrid vehicle to which a structure for mounting a battery pack in a vehicle in a second embodiment of the present invention is applied.

### BEST MODES FOR CARRYING OUT THE INVENTION

The embodiments of the present invention will be described with reference to the accompanying drawings, in which the same or corresponding components are designated by the same reference characters.

### First Embodiment

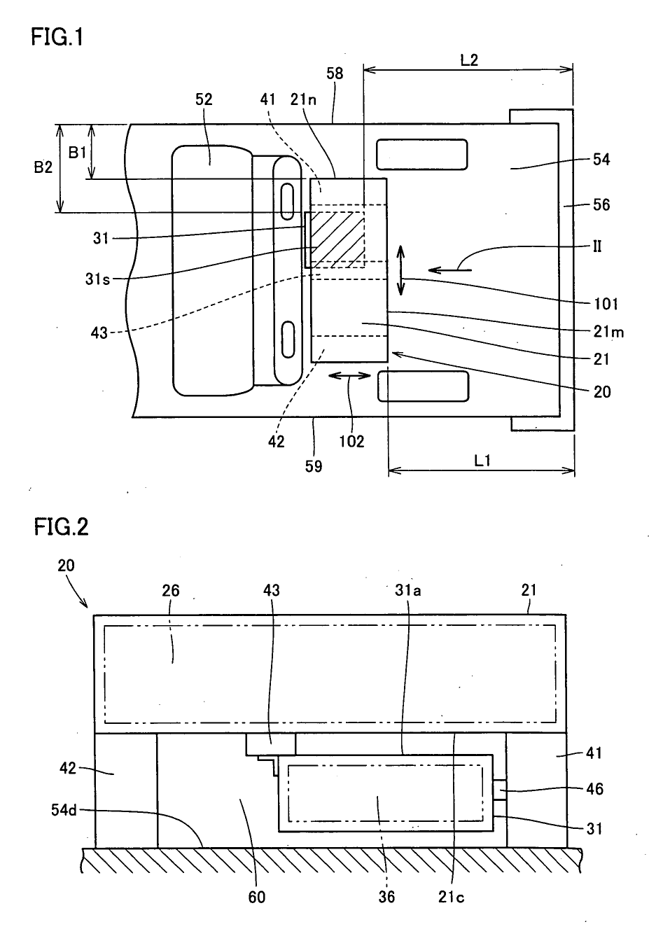

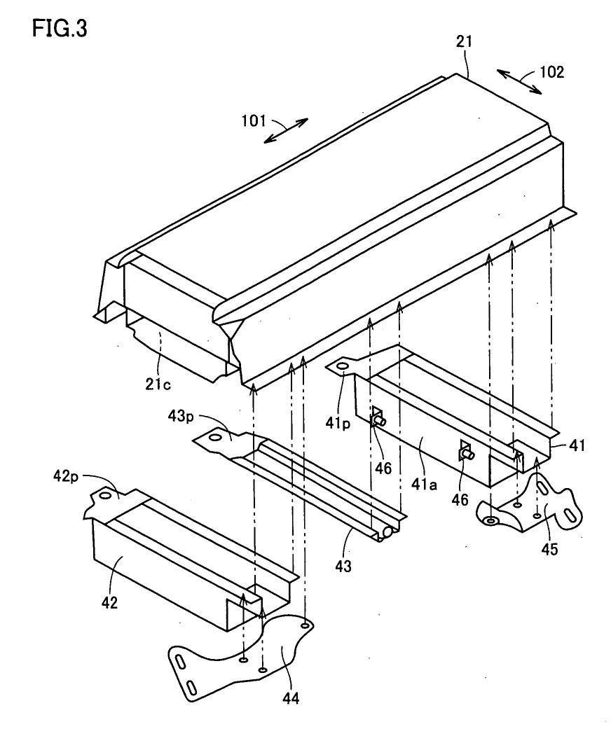

FIG. 1 is a plan view of a hybrid vehicle to which a structure for mounting a battery pack in a vehicle in a first embodiment of the present invention is applied, in which the rear portion of the hybrid vehicle is shown. FIG. 2 is a rear view of the battery pack as seen from the direction indicated by an arrow II in FIG. 1.

Referring to FIGS. 1 and 2, the hybrid vehicle shown in the figures uses, as a power source, an internal combustion engine such as a gasoline engine and a diesel engine, and a motor receiving electric power from a chargeable and dischargeable battery set 26.

A rear seat 52 is placed in the interior of the hybrid vehicle. Behind rear seat 52, a luggage room 54 which is a space for loading luggage is provided. A battery pack 20 is mounted on a floor surface 54d of luggage room 54. Battery pack 20 is disposed in a position relatively closer to rear seat 52 between rear seat 52 and a rear bumper 56 provided in the rear end of the vehicle. Rear bumper 56 corresponds to a body disposed in the rear of the vehicle. Battery pack 20 is disposed approximately in the vicinity of the center of the vehicle in the width direction of the vehicle.

Battery pack 20 includes battery set 26 and auxiliary machinery 36 which is electrically connected to battery set 26 through the wire harness (not shown). Battery set 26 is, for example, comprised of a plurality of battery cells including a lithium-ion battery which are electrically connected in series. It is to be noted that battery set 26 may be another chargeable and dischargeable secondary battery, and, for example, may include a nickel metal hydride battery.

Auxiliary machinery 36 is comprised of a plurality of devices such as a battery computer, a relay controlling a high-voltage circuit of battery set 26, various kinds of sensors detecting the voltage and the charging and discharging current of battery set 26, and a service plug interrupting the high-voltage circuit at the time of the inspection and maintenance of battery pack 20.

Battery set 26 and auxiliary machinery 36 are housed in a battery case 21 and an auxiliary machinery case 31, respectively. Battery case 21 and auxiliary machinery case 31 are, for example, formed of metal such as a galvanized steel plate.

As seen from above the vehicle, battery case 21 is formed in an approximately rectangular parallelepiped shape having a relatively longer side 21m and a relatively shorter side 21n. Longer side 21m extends in the width direction of the vehicle (direction indicated by an arrow 101 in FIG. 1), and shorter side 21n extends in the longitudinal direction of the vehicle (direction indicated by an arrow 102 in FIG. 1). That is, battery case 21 is disposed in luggage room 54 such that it has its relatively longer side extending in the width direction of the vehicle and its relatively shorter side extending in the longitudinal direction of the vehicle.

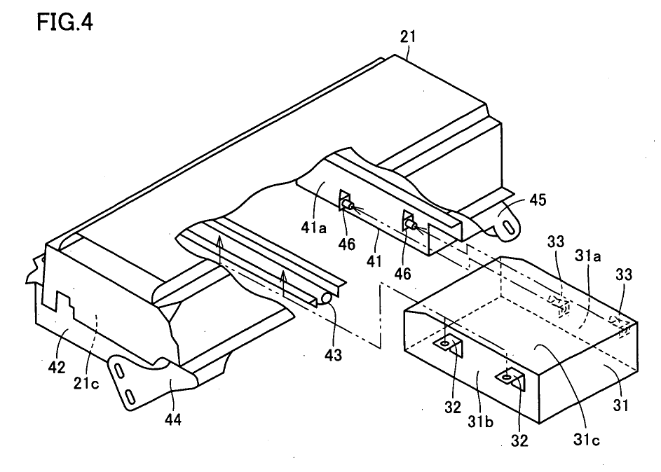

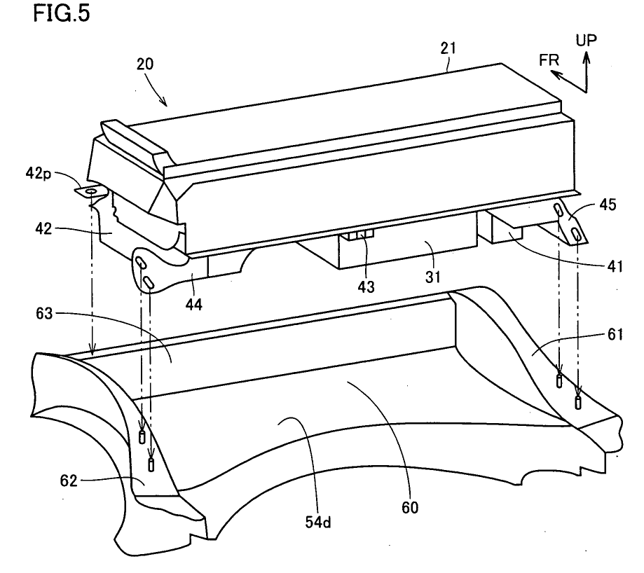

FIGS. 3 to 5 each are a perspective view of an exploded view of the battery pack in FIG. 1. In each of FIGS. 1 and 2, the simplified shape of each battery pack in FIGS. 3 to 5 is shown. Referring to FIGS. 3 to 5, the structure of the battery pack will be described in greater detail.

Battery case 21 has a bottom surface 21c facing vertically downward and formed in an approximately rectangular shape. Bottom surface 21c extends along the approximately planar surface except that projections and depressions are provided in places. Brackets 41 and 42 are attached by a bolt to both ends of bottom surface 21c, respectively, which are spaced apart from each other in the width direction of the vehicle. A bracket 43 is further attached by a bolt to bottom surface 21c between bracket 41 and bracket 42.

Brackets 41 to 43 each have approximately the same length as bottom surface 21c and extend in the longitudinal direction of the vehicle. Brackets 41 and 42 each are greater in height (length in the vertical direction) than bracket 43. Plates 45 and 44 for fixing battery pack 20 on the side of the vehicle body are attached by a bolt to brackets 41 and 42, respectively. It is to be noted that while brackets 41 to 43 and battery case 21 are described as separate components in the present embodiment, the present invention is not limited to this and brackets 41 to 43 may be formed integrally with battery case 21, for example, by welding.

Auxiliary machinery case 31 is smaller in volume than battery case 21. Furthermore, as battery case 21 and auxiliary machinery case 31 are seen from above the vehicle, auxiliary machinery case 31 is smaller in area than battery case 21.

Bracket 41 has a side surface 41a to which an angle 46 for fixing auxiliary machinery is joined by means of welding and the like. Similarly, auxiliary machinery case 31 has a pair of side surfaces 31a and 31b to which angles 33 and 32 are jointed, respectively. Auxiliary machinery case 31 is disposed directly under bottom surface 21c of battery case 21. In this position, a bolt is used to fasten angle 33 and angle 46 for fixing auxiliary machinery together and fasten angle 32 and bracket 43 together, with the result that auxiliary machinery case 31 is fixed to battery case 21.

Auxiliary machinery case 31 has a top surface 31c which faces bottom surface 21c of battery case 21. The case portions provided with bottom surface 21c and top surface 31c, respectively, each define a space for housing battery set 26 and auxiliary machinery 36, respectively. In the state where auxiliary machinery case 31 is fixed to battery case 21, bottom surface 21c and top surface 31c are spaced apart from each other and a space is provided therebetween. This configuration prevents the heat generated in auxiliary machinery 36 from being directly conducted from inside auxiliary machinery case 31 into battery case 21. This can suppress the adverse effect on the uniform cooling of battery set 26 resulting from the heat generated in auxiliary machinery 36.

Side members 61 and 62 are disposed upright on floor surface 54d of luggage room 54. Side members 61 and 62 are spaced apart from each other in the width direction of the vehicle and extend in the longitudinal direction of the vehicle. A cross member 63 is disposed upright on floor surface 54d of luggage room 54. Cross member 63 extends in the width direction of the vehicle between side members 61 and 62. Floor surface 54d extends with its three sides surrounded by side member 61, side member 62 and cross members 63.

The hybrid vehicle has an opening (not shown) provided at the rear of the vehicle for loading and unloading luggage into and from luggage room 54. Battery pack 20 is carried into luggage room 54 through the opening. Battery pack 20 is disposed such that brackets 41 and 42 are rested on floor surface 54d. A bolt is used to fasten plates 45 and 44 to side members 61 and 62, respectively, and to fasten fixing portions 41p, 42p and 43p formed in brackets 41, 42 and 43, respectively, (see FIG. 3) to cross member 63, with the result that battery pack 20 is fixed to the vehicle body.

In the present embodiment, battery set 26 and auxiliary machinery 36 are separately housed in battery case 21 and auxiliary machinery case 31, respectively, Accordingly, when maintenance is required for auxiliary machinery 36, only auxiliary machinery 36 can be removed without the need of removing battery set 26 from the vehicle body. This allows the workability at the time of the maintenance of auxiliary machinery 36 to be improved. In this case, the bolt fastening angle 33 and angle 46 for fixing auxiliary machinery together has a head facing toward the opening at the rear of the vehicle and engaged by a driver and a wrench. This facilitates access to the bolt. In the state where battery pack 20 is fixed to the vehicle body, auxiliary machinery case 31 is attachably and detachably provided while battery case 21 remains fixed to the vehicle body.

Furthermore, in the present embodiment, battery pack 20 can be readily attached to and detached from the vehicle body via the bolts fastened to plates 45 and 44 and fixing portions 41p, 42p and 43p. Consequently, the workability at the time of attachment and detachment of battery pack 20 can be improved in the case where battery pack 20 needs to be removed at the time of the service.

Furthermore, a hole used for attaching a hanger, a hook, a chain and the like for hanging battery pack 20 may be provided in brackets 41 and 42. Brackets 41 and 42 are formed with high rigidity to receive the weight of battery set 26 and auxiliary machinery 36. Therefore, the operation of lifting heavy-weight battery pack 20 can be safely and easily performed without additionally providing a bracket used exclusively at the time of the service.

Referring to FIGS. 1 and 2, battery set 26 is supported by brackets 41 and 42 at a predetermined height from floor surface 54d. Auxiliary machinery 36 is disposed in a space 60 provided between battery set 26 and floor surface 54d. Auxiliary machinery 36 is disposed in a position spaced apart from floor surface 54d. Auxiliary machinery 36 may be disposed on floor surface 54d. This configuration prevents the weight of battery set 26 from being applied to auxiliary machinery 36.

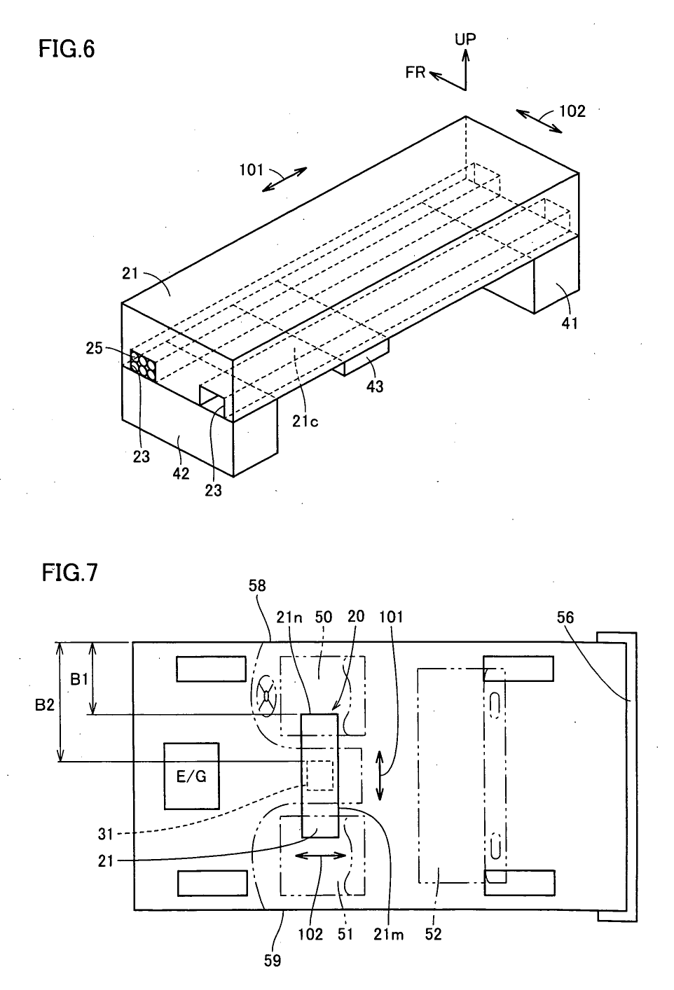

Brackets 41 and 42 may be formed of metal such as iron and copper. In this case, brackets 41 and 42 can block the electromagnetic wave which is emitted from the wire harness (a wire harness 25 in FIG. 6 described below) connecting the devices constituting auxiliary machinery 36 to battery set 26.

Bracket 41 is positioned between a side body 58 providing the side surface of the vehicle and auxiliary machinery case 31. Bracket 42 is positioned between a side body 59 providing the side surface of the vehicle on the opposite side of side body 58 and auxiliary machinery case 31. Side bodies 58 and 59 are disposed on the sides of the vehicle. Auxiliary machinery case 31 is disposed between brackets 41 and 42 in the width direction of the vehicle.

As battery pack 20 is seen from above the vehicle, auxiliary machinery case 31 has a portion 31s overlapping with battery case 21. In other words, auxiliary machinery case 31 and battery case 21 are arranged one on top of the other so as to at least provide a portion overlapping with each other in the vertical direction.

It is to be noted that battery case 21 and auxiliary machinery case 31 may be disposed such that auxiliary machinery case 31 is completely hidden behind battery case 21 as battery pack 20 is seen from above the vehicle. In this case, auxiliary machinery case 31 is contained within the vertical projection view of battery case 21. Battery case 21 and auxiliary machinery case 31 may be disposed the other way around.

Auxiliary machinery case 31 is disposed such that a distance L2 between a rear bumper 56 and auxiliary machinery case 31 is greater than a distance L1 between rear bumper 56 and battery case 21. Furthermore, auxiliary machinery case 31 is disposed such that a distance B2 between side body 58 and auxiliary machinery case 31 is greater than a distance B1 between side body 58 and battery case 21. The same applies to the positional relationships between side body 59 and battery case 21 and between side body 59 and auxiliary machinery case 31. That is, auxiliary machinery case 31 is recessed with respect to battery case 21 as seen from behind the vehicle and from the side of the vehicle.

FIG. 6 is a perspective view of the battery case which is a component of the battery pack in FIG. 1. Referring to FIG. 6, a groove portion 23 depressed from bottom surface 21c and, extending in the width direction of the vehicle is formed in battery case 21. Groove portion 23 is formed in a plurality of positions spaced apart from each other in the longitudinal direction of the vehicle. Groove portion 23 continuously extends between both ends of bottom surface 21c in the width direction of the vehicle.

In battery case 21, this configuration allows groove portion 23 extending in the width direction of the vehicle and brackets 41, 42 and 43 extending in the longitudinal direction of the vehicle to function as a rib arranged in a lattice pattern. Accordingly, battery case 21 is reinforced by brackets 41, 42 and 43, and groove portion 23. This causes battery case 21 to ensure the strength required against vibration and collision and to have strength greater than that of auxiliary machinery case 31. The structure for mounting battery pack 20 in the vehicle in the present embodiment includes brackets 41 and 42 as a support portion supporting battery set 26 in a position spaced apart from floor surface 54d within the vehicle. Battery case 21 is reinforced by brackets 41 and 42.

Various wire harnesses 25 extending from battery set 26 are passed though groove portion 23. Consequently, wire harness 25 can be reliably protected as compared to the case where the wire harness is routed on the surface of battery case 21. Furthermore, battery pack 20 can be reduced in size by saving the wiring space.

The structure for mounting battery pack 20 as a power supply device in the vehicle in the first embodiment of the present invention includes battery set 26 as a power supply mounted in the vehicle, auxiliary machinery 36 electrically connected to battery set 26 for using battery set 26, battery case 21 as a first casing housing battery set 26, and auxiliary machinery case 31 as a second casing housing auxiliary machinery 36. Battery case 21 and auxiliary machinery case 31 are disposed such that portion 31s as at least a portion of auxiliary machinery case 31 projected in the vertical direction overlaps with battery case 21.

According to the structure for mounting battery pack 20 in the vehicle in the first embodiment of the present invention configured in this way, battery case 21 and auxiliary machinery case 31 are arranged one on top of the other, to thereby allow the overall length of battery pack 20 to be reduced. Consequently, in consideration of the rear-end collision or the side collision of the vehicle, the clearance between battery pack 20 and rear bumper 56 in the longitudinal direction of the vehicle, and the clearances between battery pack 20 and side bodies 58 and 59 in the width direction of the vehicle can be sufficiently ensured. Furthermore, the projected area of battery pack 20 as seen from above the vehicle is reduced, which allows the mountability of battery pack 20 to be improved. Therefore, the path along which battery pack 20 moves can be readily ensured, for example, when battery pack 20 is carried into and from luggage room 54 through the opening at the rear of the vehicle.

Furthermore, in the present embodiment, battery case 21 is placed on the side member and the cross member by means of brackets 41 and 42. This causes space 60 to be provided between floor surface 54d of luggage room 54 and battery case 21. Auxiliary machinery case 31 is disposed in this space 60 to thereby allow more effective use of the space within the vehicle.

It is to be noted that the structure for mounting the power supply device in the vehicle in the present invention can be applied to a fuel cell hybrid vehicle (FCHV) which uses a fuel cell and a secondary battery as a power source or an electric vehicle (EV). In the hybrid vehicle in the present embodiment, the internal combustion engine is driven at an operating point of optimal fuel efficiency, whereas in the fuel cell hybrid vehicle, the fuel cell is driven at an operating point of optimal electric power generation efficiency. The secondary battery is used basically in the same manner in both of the hybrid vehicles.

Also in the present embodiment, while the power supply device in the present invention is applied to the battery pack housing the battery which generates electricity by itself by chemical change and the like, the present invention is not limited to this, and the power supply device in the present invention may be applied to a power storage device such as a capacitor which stores electricity as externally supplied.

### Second Embodiment

FIG. 7 is a plan view of the hybrid vehicle to which a structure for mounting a battery pack in a vehicle in a second embodiment of the present invention is applied. The structure for mounting the battery pack in the vehicle in the present embodiment has basically the same structure as compared to the structure for mounting battery pack 20 in the vehicle in the first embodiment. The description of the similar structure will not be repeated.

Referring to FIG. 7, in the present embodiment, battery pack 20 is disposed under a driver's seat 50 and a passenger seat 51 placed in the interior of the vehicle. As with the first embodiment, battery case 21 is disposed such that it has its relatively longer side extending in the width direction of the vehicle and its relatively shorter side extending in the longitudinal direction of the vehicle. Battery case 21 and auxiliary machinery case 31 are arranged one on top of the other such that auxiliary machinery case 31 is contained within the vertical projection view of battery case 21. Auxiliary machinery case 31 is disposed such that distance B2 between side body 58 and auxiliary machinery case 31 is greater than distance B1 between side body 58 and battery case 21. The same applies to the positional relationships between side body 59 and battery case 21 and between side body 59 and auxiliary machinery case 31.

According to the structure for mounting the battery pack in the vehicle in the second embodiment of the present invention configured in this way, particularly in consideration of the side collision of the vehicle, the clearance between battery pack 20 and side body 58 extending in the width direction of the vehicle can be sufficiently ensured. This allows the effect similar to that in the above-described first embodiment to be achieved. While battery pack 20 is disposed under the front seat in the present embodiment, the effect similar to that in the above description can also be achieved even when battery pack 20 is disposed under rear seat 52.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention is mainly applied to a vehicle provided with a power supply and auxiliary machinery for using the power supply.

1. A structure for mounting a power supply device in a vehicle, comprising:
a power supply mounted in the vehicle;
auxiliary machinery electrically connected to said power supply for using said power supply;
a first casing housing said power supply; and
a second casing housing said auxiliary machinery,
said first casing and said second casing being disposed such that at least a portion of said second casing projected in a vertical direction overlaps with said first casing,
said second casing being disposed under said first casing, and
said second casing being attachable and detachable while said first casing remains fixed to a vehicle body.

2. The structure for mounting a power supply device in a vehicle according to claim 1, wherein said power supply is mounted in a luggage room provided on a rear side of the vehicle.

3. The structure for mounting a power supply device in a vehicle according to claim 2, wherein
said vehicle has an opening formed for loading and unloading luggage into and from said luggage room, and
a head of a bolt fastening said second casing on a side of a vehicle body faces toward said opening.

4. The structure for mounting a power supply device in a vehicle according to claim 1, wherein
said first casing is formed in an approximately rectangular parallelepiped shape having a direction of a longer dimension and a direction of a shorter dimension as seen from above the vehicle, and
said power supply is mounted in the vehicle such that a width direction of the vehicle approximately corresponds to said direction of the longer dimension and a longitudinal direction of the vehicle approximately corresponds to said direction of the shorter dimension.

5. The structure for mounting a power supply device in a vehicle according to claim 1, the power supply device being placed vertically upward on an installation surface which is a floor surface of the vehicle, further comprising:
a support portion supporting said first casing in a position spaced apart from an installation surface within the vehicle,
said second casing being disposed in a position spaced apart from said installation surface between said installation surface and said first casing.

6. The structure for mounting a power supply device in a vehicle according to claim 1, the power supply device being placed vertically upward on an installation surface which is a floor surface of the vehicle, further comprising
a metallic support portion supporting said first casing in a position spaced apart from said installation surface within the vehicle,
said second casing being disposed between said installation surface and said first casing.

7. The structure for mounting a power supply device in a vehicle according to claim 1, said power supply being mounted in a luggage room provided on a rear side of the vehicle, further comprising:
a cross member disposed upright on a floor surface of said luggage room, extending in a width direction of the vehicle, and placed on a front of said second casing with respect to the vehicle; and
a first bracket, a second bracket and a third bracket provided on a floor surface of said first casing and extending in a longitudinal direction of the vehicle.

8. The structure for mounting a power supply device in a vehicle according to claim 7, wherein there is a space provided between said second bracket and said second casing.

9. The structure for mounting a power supply device in a vehicle according to claim 1, wherein
said power supply is mounted in a luggage room provided on a rear side of the vehicle,
said vehicle has an opening provided at a rear of the vehicle for loading and unloading luggage into and from said luggage room, and
said second casing is attachable and detachable from the rear of the vehicle while said first casing remains fixed to the vehicle body.
